(19) United States
(12) Patent Application Publication
(10) Pub. No.: US 2015/0371240 A1
(43) Pub. Date: Dec. 24, 2015

(54) COMMERCIAL CARD PORTFOLIO OPTIMIZATION

(71) Applicant: MASTERCARD INTERNATIONAL INCORPORATED, Purchase, NY (US)

(72) Inventors: Cynthia P. Meyer, Woodstock, IL (US); Adam Granoff, Greenwich, CT (US); Arun Acharya, Tuckahoe, NY (US)

(21) Appl. No.: 14/308,178

(22) Filed: Jun. 18, 2014

(51) Int. Cl. G06Q 30/02

(52) U.S. Cl. CPC G06Q 30/0201; G06Q 30/0204

(57) ABSTRACT

A method of targeting commercial entities for transaction-card usage revenue enhancement. The method includes functionally combining electronically searchable data sources concerning actual or potential commercial transaction-card using entities. The electronically searchable data sources include data concerning the commercial transaction card-using entities, relating to its relationship with a transaction-card issuer, firmographic data, and transaction record data concerning transaction card usage by commercial transaction card-using entities. The first plurality of electronically searchable data sources is electronically searched to identify one or more model-performance actual or potential commercial transaction-card using entities. A set of key metric categories is identified among the electronically searchable data sources, in which the model-performance card-using entities exceed their peers. A list derived from the actual or potential commercial transaction-card using entities is prepared, including of those actual or potential commercial transaction-card using entities whose measurements in one or more key metric categories exceed their peers. Also disclosed are a system for carrying out such a method, and a medium storing a program of instructions for carrying out such a method.

### BACKGROUND

1. Field of the Disclosure

The present disclosure relates to electronic transaction processing. More specifically, the present disclosure is directed to method and system for data analysis of buying patterns in support of marketing cashless transaction services to commercial entities.

2. Brief Discussion of Related Art

The use of payment devices for a broad spectrum of cashless transactions has become ubiquitous in the current economy, according to some estimates accounting for hundreds of billions or even trillions of dollars in transaction volume annually. While a layman might typically consider the cashless transaction payment scenario as it is applied in retail transactions of common experience, it is further becoming the case that the use of cashless payment devices is becoming more prevalent to facilitate commercial transactions.

Those of ordinary skill in the art will be acquainted with a purchase order system of commercial buying. A commercial buying entity delegates purchasing power, for example to one of its employees, and will have a system in place to issue a purchase order, having a unique purchase order number, for each authorized transaction. The purchase order will often specifying goods and price, among other terms defining the purchase authority. Each purchase order can be associated with a particular vendor, and for a particular amount of transaction. The respective vendor will then cite the purchase order number to request payment on a subsequent invoice for the transaction.

This purchase order system is cumbersome, however. At least for the buyer, there is conservable administrative overhead. On the other hand, the seller must typically still wait for payment according to the terms of the sale. In recent years, the purchase order system has been increasing supplanted by use of cashless transaction devices, e.g., payment cards, etc. In this way, a payment card may be issued in the name of an authorized officer on behalf of the commercial entity. The transaction device may have limitations on its authority corresponding to the authorized cardholder. The use of a transaction device in the ordinary stream of commerce also offers the benefit to the vendor of instant and available payment for invoices, among many other benefits.

The process and parties typically involved in consummating a cashless payment transaction can be visualized for example as presented in FIG. 1, and can be thought of as a cycle, as indicated by arrow 10. A device holder 12, for example a purchasing agent, may present a payment device 14, for example a payment card, transponder device, NFC-enabled smart phone, among others and without limitation, to a merchant 16 as payment for goods and/or services. For simplicity the payment device 14 is depicted as a credit card, although those skilled in the art will appreciate the present disclosure is equally applicable to any cashless payment device, for example and without limitation, contactless RFID-enabled devices including smart cards, NFC-enabled smartphones, electronic mobile wallets, or the like. The payment device 14 here is emblematic of any transaction device, real or virtual, by which the device holder 12 as payer and/or the source of funds for the payment may be identified. Moreover, in the context of the present disclosure, a cashless payment device 14 may be only virtual in nature. A virtual payment device 14 is particularly useful in the commercial card use setting, as commercial card uses often do not involve face-to-face interaction between the payer and the merchant of goods or services at the point of payment.

In cases where the merchant 16 has an established merchant account with an acquiring bank (also called the acquirer) 20, the merchant 16 communicates with the acquirer to secure payment on the transaction. An acquirer 20 is a party or entity, typically a bank, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction through a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment device 14 from a device holder 12, despite not having a merchant account with an acquirer 20.

The acquirer 20 routes the transaction request to the network operator 22. The data included in the transaction request will identify the source of funds for the transaction. With this information, the network operator 22 routes the transaction to the issuer 24. An issuer 24 is a party or entity, typically a bank, which is authorized by the network operator 22 to issue payment devices 14 on behalf of its customers (e.g., device holder 12) for use in transactions to be completed on the network. The issuer 24 also provides the funding of the transaction to the network provider 22 for transactions that it approves in the process described. The issuer 24 may approve or authorize the transaction request based on criteria such as a device holder's credit limit, account balance, or in certain instances, more detailed and particularized criteria including transaction amount, merchant classification, etc., which may optionally be determined in advance in consultation with the device holder and/or a party having financial ownership or responsibility for the account(s) funding the payment device 14, if not solely the device holder 12.

The decision by the issuer 24 to authorize or decline the transaction is routed through the network operator 22 and acquirer 20, ultimately to the merchant 16 at the point of sale. In a one-message based transaction system, the transaction is thus consummated, with payment routed between issuer 24 and acquirer 20 via the network operator. Alternately, in a two-message system, the approval of the transaction by the issuer 24 is subsequently settled or paid to the acquirer 20, who then reconciles with the merchant.

The issuer 24 may then look to its customer, e.g., device holder 12 or other party having financial ownership or responsibility for the account(s) funding the payment device 14, for payment on approved transactions, for example and without limitation, through an existing line of credit where the payment device 14 is a credit card, or from funds on deposit where the payment device 14 is a debit card. Generally, a statement document 26 provides information on the account of a device holder 12, including merchant data as provided by the acquirer 20 via the network operator 22.

The network operator 22 can further build and maintain a data warehouse that stores and augments transaction data for use in marketing, macroeconomic reporting, etc. This data warehouse includes the transaction records of cardholders and merchants, from which information may be gleaned concerning their respective buying and selling patterns, etc. The data warehouse can be advantageously supplemented by third party provided data, among these and without limitation credit reporting agency data sources (e.g., Dunn & Bradstreet, Hoover's or the like), industry intelligence data (Standard & Poor's, etc.).

### SUMMARY

Both the network operator 22, and the issuer 24, inter alia, have an interest in growing their market for commercial payment services facilitated by the cashless transaction cycle described above. To this extent, the issuer 24 can look to the highest performing of its clients, in order to use their characteristics as models of other potential high-volume users. The instant disclosure proposes a method of user analysis that will identify characteristics of commercial cashless payment users to serve as models to drive expansion of usage.

Therefore, provide according to the instant disclosure is a method of targeting commercial entities for transaction-card usage revenue enhancement. The presently disclosed method includes functionally combining a first plurality of electronically searchable data sources concerning a second plurality of actual or potential commercial transaction-card using entities, where the first plurality of electronically searchable data sources including data concerning respective ones of the second plurality of commercial transaction card-using entities, relating to its relationship with a transaction-card issuer, firmographic data concerning the respective ones of the second plurality of commercial transaction card-using entities, and transaction record data concerning transaction card usage by the respective one of the second plurality of commercial transaction card-using entities. The first plurality of electronically searchable data sources is electronically searched to identify one or more model-performance ones of the second plurality of actual or potential commercial transaction-card using entities. A set of key metric categories is identified among the first plurality of electronically searchable data sources, in which the model-performance card-using entities exceed their peers. A list derived from the second plurality of actual or potential commercial transaction-card using entities is prepared, the list including of those actual or potential commercial transaction-card using entities whose measurements in one or more key metric categories exceed their peers.

In a further embodiment of the disclosed method, the data concerning respective ones of the second plurality of commercial transaction card-using entities relating to its relationship with a transaction-card issuer comprises one or more of a number of transaction cards held by the customer, the tenure of business of the transaction card-using entity with the issuer, the market segment a particular commercial card entity represents to the issuer, the amount of credit line advanced to the card user by the issuer, credit risk data concerning the transaction card-using entities, and whether the transaction card-using entity's account is actively managed by the issuer.

In a further embodiment of the disclosed method, the firmographic data concerning the respective ones of the second plurality of commercial transaction card-using entities comprises one or more of industry segment data, revenue data, issuer profitability data, creditworthiness data, forecast or historical data as to any of these.

In a further embodiment of the disclosed method, transaction record data comprises one or more of total spend data, spend category data, share of spending data among categories, and top merchants patronized.

In a further embodiment of the disclosed method, a model-performance commercial transaction card-using entity is measured according to one or more of total spend volume, and relative share of spending across multiple merchant categories.

In a further embodiment of the disclosed method, the list comprises those actual or potential commercial transaction-card using entities whose measurements in a plurality of the key metric categories exceed their peers.

In another aspect of the present disclosure, a non-transitory machine readable recording medium stores thereon a program of instructions which, when executed by a computer processor, cause the processor to execute a method of targeting commercial entities for transaction-card usage revenue enhancement, including the features and aspects described above and hereinafter.

In another aspect of the present disclosure, a system for targeting commercial entities for transaction-card usage revenue enhancement, includes a processor, and a non-transitory machine readable recording medium stores thereon a program of instructions which, when executed by the processor, cause the processor to execute the method, including the features and aspects described above and hereinafter.

These and other purposes, goals and advantages of the present disclosure will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates schematically the process and parties typically involved in consummating a cashless payment transaction; and

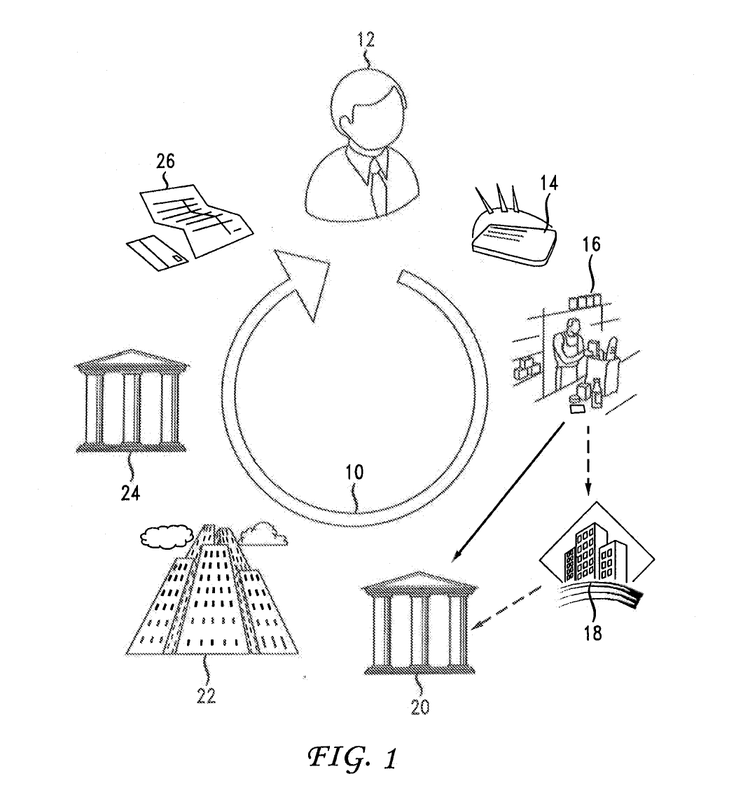

FIG. 2 illustrates a flowchart for a process of functional compilation of multiple data sources into a single database structure concerning commercial card users;

FIG. 3 illustrates a topical segmentation for automated benchmarking;

FIG. 4 illustrates a Venn diagram showing the intersection and overlap of certain commercial card user characteristics; and

FIG. 5 illustrates schematically a representative computer of the system implementing the presently disclosed methods.

### DETAILED DESCRIPTION

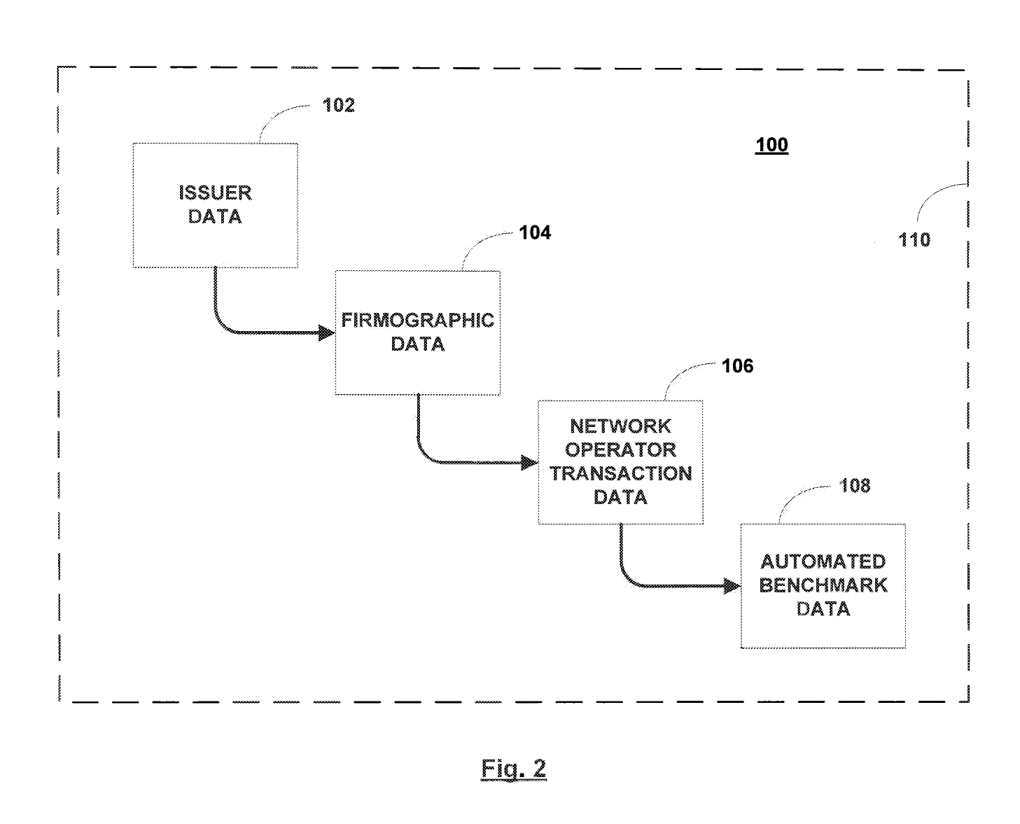

With reference to FIG. 2, illustrated is a flowchart, generally 100, for the functional compilation of multiple data sources into a single database structure concerning commercial card users. The functional combination of these plural data sources will mean, at a minimum, that the plural data sources are addressable according to a common or interoperative index, by which commercial entities about which data is stored among the plural sources can be identified, and respective data concerning those entities retrieved from the plural sources.

The process according to the instant disclosure combines several types and sources of data. For example, issuer data 102 is known to the issuer based upon its relationship with a given commercial card user. This information may be inherent to establishing and building the cardholder relationship and already known to the issuer 24. For example, issuer data 102 may include which cards may be attributed as a group to which commercial card user, the number of transaction cards held by the customer, their tenure of business with the issuer 24, the market segment a particular commercial card entity represents to the issuer 24, the amount of credit line advanced to the card user by the issuer 24, credit risk data concerning the commercial card user, and whether the commercial card entity's account is actively managed by the issuer 24.

A further layer of information comprises firmographic data 104 concerning corporate card users, particularly those that are current or prospective clients of the issuer 24. Generally, this firmographic data 104 is sourced from free or paid commercial sources, for example and without limitation credit reporting agency data sources, industry intelligence data sources, including without limitation, Dunn & Bradstreet, Manta, Hoover's, or the like. Firmographic data 104 may include industry segment, annual sales, number of employees, history and projection of company size.

A still further layer of information comprises transaction data 106 collected by the network operator 22 in their daily operations. The transaction data 106 is a fertile source of information from which spending patterns can be identified and analyzed. For example, data metrics such as aggregate spending amount, and category of spending can be readily discerned from the transaction record.

Having functionally combined at least issuer data 102, firmographic data 104, and transaction data 106, a first level of automated benchmarking 108 is added to form a combined data set 110. Using the automated benchmarking 108 in combination with issuer data 12, firmographic data 104 and transaction data 106 can identify a limited set of likely targets for card usage and revenue growth. Highest-volume entities are identified from transactional data. These high-volume entities are then compared to their peers in a number of categories to identify any characteristics in which they exceed their peers. Accordingly, other commercial card-using entities having similar characteristics, but lower spending on cards, are identified as likely candidates for revenue enhancement and growth. Moreover, the process lends itself readily to automation.

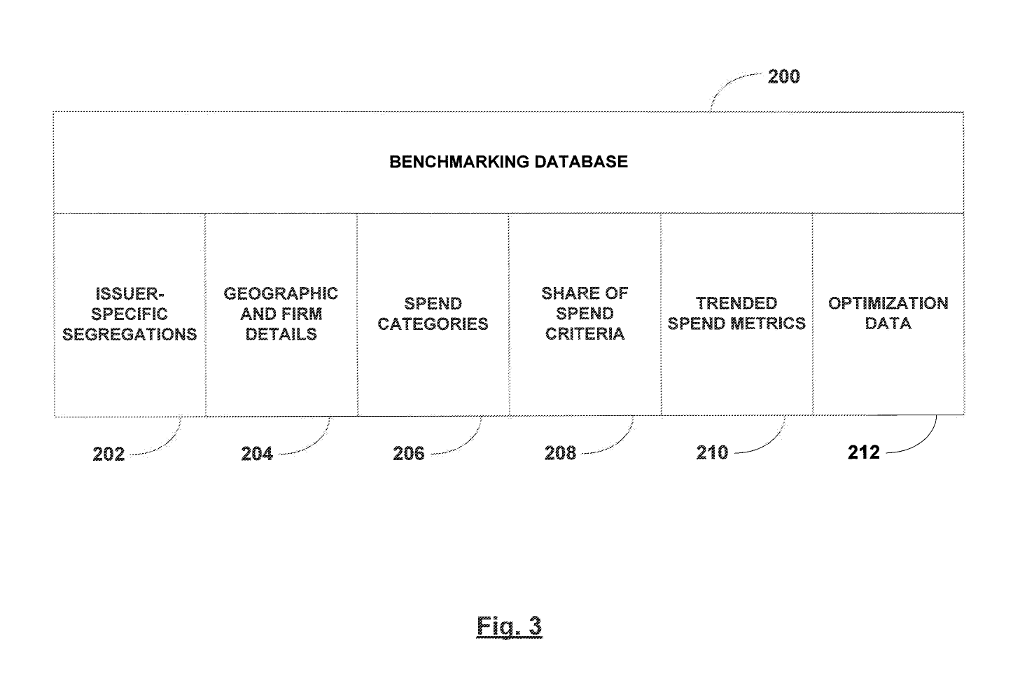

Turning now to FIG. 3, illustrated are a breakdown of exemplary categories, generally 200, for automated benchmarking 108. A first exemplary data category may be based upon issuer-specific market segmentations 202. For example, the market for issuing banks, i.e., issuers 24, is segmented by target clientele. That is, certain issuing banks focus their products and services to the needs of individual consumers (consumer banks), others market to small businesses (business banks), still others to medium size businesses (commercial banks), and still others to large scale corporations (corporate banks). It will be understood that there is overlap in clientele at the margins, and certain banking organizations may be structured to serve more than one market segment. Notwithstanding, the market segment that a particular issuer 24 is oriented towards serving will affect the characteristics of its card-using customers, and therefore can be considered as part of the present analysis.

Additional issuer-specific segmentations may include a separation between issuer clients whose accounts are actively managed, and unmanaged accounts. Among managed accounts, the account manager can be considered. Certain customers can be identified by an issuer 24 as a strategic customer, and analysis can be conducted among the strategic customers only, for example. The foregoing will be considered, without limitation, among a group of issuer-specific segmentation 202.

A further exemplary data category may be based upon geographic and firm details 204. That is to say, certain characteristics of the companies per se, for example location, industry, revenue, etc. may form the basis for a first threshold screening to identify likely candidates for card usage growth to target marketing efforts.

A next exemplary data category may be based upon the categories of spending 206, which is to say categories of merchant patronized, using the transaction devices. For example, merchants are routinely classified by their line of work. For purposes of commercial card use analysis, merchants can also be grouped according to their function with respect to the purchasing entity. For example, certain merchants, such as hotels and restaurants, fall into a broader “Travel and Entertainment” category. In particular, these serve generally the same purpose to a business client as they would to a leisure client. On the other hand, trade merchants or the like would fall under a Business-to-Business (B2B) category. A particular commercial card user making use of the card in one category may be a good candidate to introduce expansion of use into others. Moreover, experience has shown that the two different classes of user represent a different type of use of the card. In particular, adoption of card use in B2B transactions represents a greater level of commitment to card use, and also greater spend volume potential relative to business revenue. In a related aspect, a further data category may be a relative share of spending 208, i.e., one or more ratios or other comparisons of spending by a commercial card user between the various spend categories, e.g., travel & entertainment vs. B2B categories, among others.

A further exemplary data category may be based upon Trended Spending Metrics 210. Trended spending metrics can include the length of tenure a particular commercial card user has with the issuer 24. It may include a record of spending volume over time. Another exemplary Trended Spending Metric may be a number of cards or payment devices issued to a given commercial card user.

A further exemplary data category is considered Optimization Data 212. Optimization data may include industry benchmarking data, such as those published by market research organizations. Industry benchmarking data can include ranking of a business entity among its peers in one or more relevant metrics. In addition to an entity's own metrics, its comparative ranking can be used to forecast targets of card spending potential.

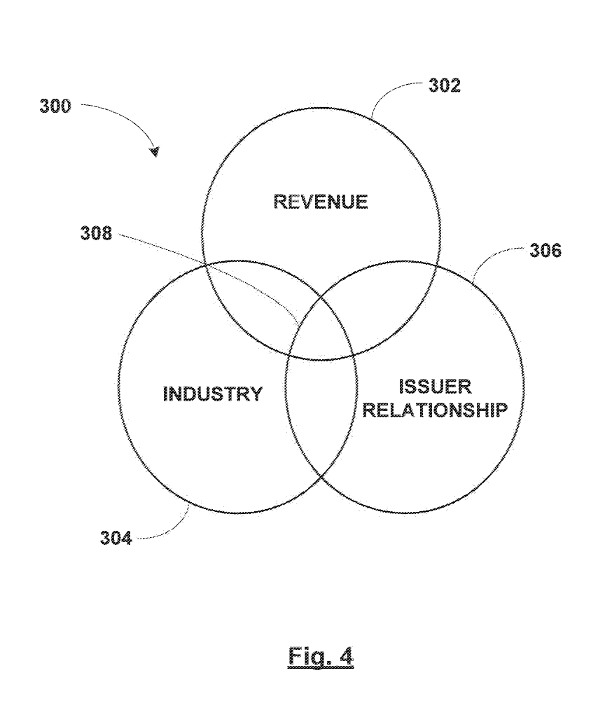

Referring now to FIG. 4, illustrated is a Venn diagram, generally 300, illustrating the intersection and overlap of certain commercial card user characteristics. Commercial card users may be placed on the Venn diagram 300 according to the categories in which they exceed threshold levels. For example, the issuer 24 or network operator 22 may choose to focus on firm revenue 302, i.e., a dollar value of sales by the entity Firm revenue 302 happens to be one of the firmographic data category 204 metrics (See FIG. 3). Industry segment 304—also within the firmographic category 204, and issuer relationship 306 are also a part of diagram 300. Issuer relationship 306 can describe the level of business that a particular card user is conducting with the issuer 24, and may be a qualitative measure, for example by category of business relationship which can be among the issuer-specific category 202, or a quantitative measure, by dollar volume of business conducted, and/or revenue derived by the issuer from the business relationship. Using the Venn diagram 300, when a card user or potential card user meets or exceeds a threshold value in any category of interest, they are placed on the diagram. When a card user or potential card user meets or exceeds a threshold value in more than one category, they fall within the intersection 308 of the Venn circles, and are a more preferred candidate to explore increased card usage and revenue growth.

Of course the categories listed in FIG. 4 are merely exemplary. In another embodiment the particular categories and thresholds may be derived from an analysis of current commercial card user spending patterns. In particular, highest volume users may be used as models in any of their measurements for benchmarking other users or potential users. The setting of thresholds themselves may be done in many ways. Threshold values may be chosen according to average, mean or median values in a given category. The data with respect to highest-performing users, overall or in any given category, may be used to set a ‘best in class’ or target thresholds.

The system and method according to the present disclosure presents multiple benefits for both the issuer 24 and network operator 22 from a revenue growth perspective. In the first instance, by combining the multiple data sources which were previously maintained separately for separate purposes, it is possible to discern characteristics of high-volume commercial card users that were not apparent from any component data source separately. Accordingly, these characteristics may be used to identify likely candidates to implement commercial card usage or to grow current usage.

Furthermore, the combination of data sources allows the user to impute missing data from one commercial card user entity to another commercial card user entity, particularly in the case of related business entities. In particular, the instant assignee has developed and disclosed techniques for partial and approximate matching of entity data from disparate sources and formats, as well as for merchant data aggregation. See, e.g., U.S. Pat. No. 8,458,071, and any related applications, or U.S. patent application Ser. No. 13/791,078, filed 8 Mar. 2013, and any related applications. The foregoing applications are commonly assigned with the instant application, and the complete disclosures of both, and any related applications, are hereby incorporated by reference for all purposes.

Moreover, the data mining based on the combined database may be automated in order to identify top-performing users; identify the characteristics of those top-performing users according to one or more predetermined categories; compare the characteristics of those top-performing users to industry peers in order to identify one or more key measurements; and set threshold levels for benchmarking likely opportunities for portfolio acquisition and enhancement; and return a list of the most likely prospective commercial card users based upon their metrics in one or more key categories.

It will be appreciated by those skilled in the art that the methods as described above may be operated by a machine operator having a suitable interface mechanism, and/or more typically in an automated manner, for example by operation of a network-enabled computer system including a processor executing a system of instructions stored on a machine-readable medium, RAM, hard disk drive, or the like. The instructions will cause the processor to operate in accordance with the present disclosure. Moreover, the methods described herein may be performed by the network operator 22, given access to the issuer data 102 as noted. Alternately, the network operator 22 may provide the system or software for implementing the described method to the issuer 24 as a tool for their use.

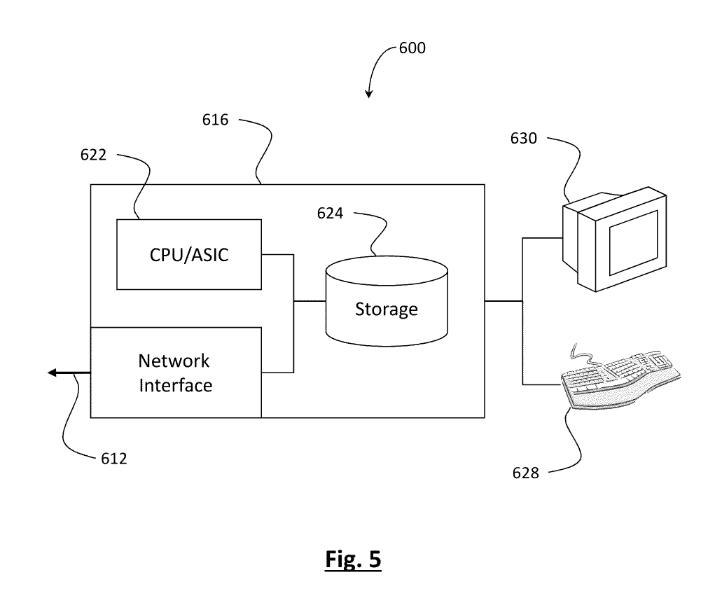

Turning then to FIG. 5, illustrated schematically is a representative computer 616 of the system, generally 600. The computer 616 includes at least a processor or CPU 622 which is operative to act on a program of instructions stored on a computer-readable medium 624. Execution of the program of instruction causes the processor 622 to carry out, for example, the methods described above according to the various embodiments. It may further or alternately be the case that the processor 622 comprises application-specific circuitry including the operative capability to execute the prescribed operations integrated therein. The computer 616 will in many cases include a network interface 626 for communication with an external network 612. Optionally or additionally, a data entry device 628 (e.g., keyboard, mouse, trackball, pointer, etc.) facilitates human interaction with the server, as does an optional display 630. In other embodiments, the display 630 and data entry device 628 are integrated, for example a touch-screen display having a GUI.

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

I/We claim:

1. A method of targeting commercial entities for transaction-card usage revenue enhancement, the method comprising:
functionally combining a first plurality of electronically searchable data sources concerning a second plurality of actual or potential commercial transaction-card using entities,
the first plurality of electronically searchable data sources comprising data concerning respective ones of the second plurality of commercial transaction card-using entities relating to its relationship with a transaction-card issuer, firmographic data concerning the respective ones of the second plurality of commercial transaction card-using entities; and transaction record data concerning transaction card usage by the respective one of the second plurality of commercial transaction card-using entities;
electronically searching the first plurality of electronically searchable data sources to identify one or more model-performance ones of the a second plurality of actual or potential commercial transaction-card using entities;
identifying a set of key metric categories among the first plurality of electronically searchable data sources in which the model-performance card-using entities exceed their peers;
preparing a list derived from the second plurality of actual or potential commercial transaction-card using entities, of those actual or potential commercial transaction-card using entities whose measurements in one or more key metric categories exceed their peers.

2. The method according to claim 1, wherein the data concerning respective ones of the second plurality of commercial transaction card-using entities relating to its relationship with a transaction-card issuer comprises one or more of a number of transaction cards held by the customer, the tenure of business of the transaction card-using entity with the issuer or as a card-user overall, the market segment a particular commercial card entity represents to the issuer, the amount of credit line advanced to the card user by the issuer, credit risk data concerning the transaction card-using entities, and whether the transaction card-using entity's account is actively managed by the issuer.

3. The method according to claim 1, wherein the firmographic data concerning the respective ones of the second plurality of commercial transaction card-using entities comprises one or more of industry segment data, revenue data, issuer profitability data, creditworthiness data, forecast or historical data as to any of these.

4. The method according to claim 1, wherein transaction record data comprises one or more of total spend data, spend category data, share of spending data among categories, and top merchants patronized.

5. The method according to claim 1, wherein a model-performance commercial transaction card-using entities is measured according to one or more of total spend volume, and relative share of spending across multiple merchant categories.

6. The method according to claim 1, wherein the list comprises those actual or potential commercial transaction-card using entities whose measurements in a plurality of the key metric categories exceed their peers.

7. A non-transitory computer-readable storage medium, having thereon a program of instructions, which, when executed by a computer processor, cause the processor to carry out a method of targeting commercial entities for transaction-card usage revenue enhancement, the method comprising:
functionally combining a first plurality of electronically searchable data sources concerning a second plurality of actual or potential commercial transaction-card using entities,
the first plurality of electronically searchable data sources comprising data concerning respective ones of the second plurality of commercial transaction card-using entities relating to its relationship with a transaction-card issuer, firmographic data concerning the respective ones of the second plurality of commercial transaction card-using entities; and transaction record data concerning transaction card usage by the respective one of the second plurality of commercial transaction card-using entities;
electronically searching the first plurality of electronically searchable data sources to identify one or more model-performance ones of the a second plurality of actual or potential commercial transaction-card using entities;
identifying a set of key metric categories among the first plurality of electronically searchable data sources in which the model-performance card-using entities exceed their peers;
preparing a list derived from the second plurality of actual or potential commercial transaction-card using entities, of those actual or potential commercial transaction-card using entities whose measurements in one or more key metric categories exceed their peers.

8. The non-transitory computer-readable storage medium according to claim 7, wherein the method further comprises:
the data concerning respective ones of the second plurality of commercial transaction card-using entities relating to its relationship with a transaction-card issuer comprises one or more of a number of transaction cards held by the customer, the tenure of business of the transaction card-using entity with the issuer or as a card-user overall, the market segment a particular commercial card entity represents to the issuer, the amount of credit line advanced to the card user by the issuer, credit risk data concerning the transaction card-using entities, and whether the transaction card-using entity's account is actively managed by the issuer.

9. The non-transitory computer-readable storage medium according to claim 7, wherein the method further comprises:
the firmographic data concerning the respective ones of the second plurality of commercial transaction card-using entities comprises one or more of industry segment data, revenue data, issuer profitability data, creditworthiness data, forecast or historical data as to any of these.

10. The non-transitory computer-readable storage medium according to claim 7, wherein the method further comprises:
transaction record data comprises one or more of total spend data, spend category data, share of spending data among categories, and top merchants patronized.

11. The non-transitory computer-readable storage medium according to claim 7, wherein the method further comprises:
a model-performance commercial transaction card-using entities is measured according to one or more of total spend volume, and relative share of spending across multiple merchant categories.

12. The non-transitory computer-readable storage medium according to claim 7, wherein the method further comprises:
the list comprises those actual or potential commercial transaction-card using entities whose measurements in a plurality of the key metric categories exceed their peers.

13. A system for targeting commercial entities for transaction-card usage revenue enhancement, the system comprising:
a processor;
a non-transitory, machine-readable storage medium, storing thereon a program of instructions which, when executed by the processor, cause to processor to carry out the method comprising:
functionally combining a first plurality of electronically searchable data sources concerning a second plurality of actual or potential commercial transaction-card using entities,
the first plurality of electronically searchable data sources comprising data concerning respective ones of the second plurality of commercial transaction card-using entities relating to its relationship with a transaction-card issuer, firmographic data concerning the respective ones of the second plurality of commercial transaction card-using entities; and transaction record data concerning transaction card usage by the respective one of the second plurality of commercial transaction card-using entities;
electronically searching the first plurality of electronically searchable data sources to identify one or more model-performance ones of the a second plurality of actual or potential commercial transaction-card using entities;
identifying a set of key metric categories among the first plurality of electronically searchable data sources in which the model-performance card-using entities exceed their peers;
preparing a list derived from the second plurality of actual or potential commercial transaction-card using entities, of those actual or potential commercial transaction-card using entities whose measurements in one or more key metric categories exceed their peers.

14. The system according to claim 13, wherein the method further comprises:
the data concerning respective ones of the second plurality of commercial transaction card-using entities relating to its relationship with a transaction-card issuer comprises one or more of a number of transaction cards held by the customer, the tenure of business of the transaction card-using entity with the issuer or as a card-user overall, the market segment a particular commercial card entity represents to the issuer, the amount of credit line advanced to the card user by the issuer, credit risk data concerning the transaction card-using entities, and whether the transaction card-using entity's account is actively managed by the issuer.

15. The system according to claim 13, wherein the method further comprises:
the firmographic data concerning the respective ones of the second plurality of commercial transaction card-using entities comprises one or more of industry segment data, revenue data, issuer profitability data, creditworthiness data, forecast or historical data as to any of these.

16. The system according to claim 13, wherein the method further comprises:
transaction record data comprises one or more of total spend data, spend category data, share of spending data among categories, and top merchants patronized.

17. The system according to claim 13, wherein the method further comprises:
a model-performance commercial transaction card-using entities is measured according to one or more of total spend volume, and relative share of spending across multiple merchant categories.

18. The system according to claim 13, wherein the method further comprises:
the list comprises those actual or potential commercial transaction-card using entities whose measurements in a plurality of the key metric categories exceed their peers.
